(19) United States
(12) Patent Application Publication
(10) Pub. No.: US 2013/0144770 A1
(43) Pub. Date: Jun. 6, 2013

(54) ALERT GENERATION BASED ON A GEOGRAPHIC TRANSGRESSION OF A VEHICLE

(71) Applicants: Brian Boling, Knoxville, TN (US); Tom Beerle, Burlingame, CA (US); Curtis Schantz, Scottsdale, AZ (US)

(72) Inventors: Brian Boling, Knoxville, TN (US); Tom Beerle, Burlingame, CA (US); Curtis Schantz, Scottsdale, AZ (US)

(73) Assignee: PROCONGPS, INC., Knoxville, TN (US)

(21) Appl. No.: 13/310,629

(22) Filed: Dec. 2, 2011

(51) Int. Cl. G06Q 40/00; G08G 1/123

(52) U.S. Cl. 705/35; 340/989

(57) ABSTRACT

A method of associating a geospatial boundary area with a vehicle currently having a security interest, determining that the vehicle currently having the security interest has transgressed the geospatial boundary area, and generating an alert communication to a party having the security interest in the vehicle based on the transgression is disclosed. Also disclosed is the comparison of geo spatial data received from a transmitter installed within the vehicle with a predetermined event specified by a lender or provider and dynamically generated using the geospatial data, to make a determination of a predictive indicator of default, delinquency, or loss of value of an asset.

### FIELD OF TECHNOLOGY

This disclosure relates generally to using geospatial data to alert a party having a security interest in a collateral upon occurrence of an event affecting the collateral, and in one example embodiment, to notify a lender of an increased risk of default and/or delinquency of a vehicular collateral based on geospatial data and pattern of usage information received from a transmitter capable of transmitting geospatial data installed within the vehicle.

### BACKGROUND

Transmitters built using technology that communicates geospatial data may be based on a worldwide navigational and surveying facility dependent on the reception of signals from an array of orbiting satellites (e.g., Global Positioning System (GPS) technology). Another example might be a Real Time Locator System (RTLS) which uses Radio Frequency Identification (RFID) technology to transmit the physical location of RFID tagged objects. In addition, such transmitters may be placed directly within vehicles by Original Equipment Manufacturers (OEMs). For example, car manufacturers may install OEM telematics solutions (e.g., OnStar™) within all their vehicles. The use of GPS, RTLS, RFID or OEM telematics based transmitters to enable the quick and easy repossession of collateral (e.g., a vehicle) is gaining prominence. In the subprime vehicle finance market, such transmitters are frequently used to track a borrower's vehicle and to alert a party of interest (e.g., a provider of the transmitter and the vehicle tracking service, or a lender) of the location of the vehicle. This may particularly be the case if the location of the vehicle becomes necessary for repossession purposes when the borrower defaults or is delinquent on the underlying loan securing the purchase of the vehicle.

Generally, vehicles, such as automobiles, are financed through captive OEM lenders and third party lending institutions such as a bank, a credit union, a specialty finance company or an automobile dealer. The borrower or purchaser of the vehicle borrows money from the lending institution and makes monthly payments on the loan to the lending institution. Typically, title to the vehicle remains with the lending institution until the loan amount has been paid in full. Therefore, lending institutions are susceptible to a partial or total loss of their asset (e.g., the vehicle that is used as collateral by the lending institution in a loan) if the borrower defaults on his/her loan obligations. As such, consistent on-time payments from the borrower to the lending institution is of paramount importance to prevent default on the loan and loss of value for the lending institution. Obtaining information on events that could be reliable indicators of whether or not the borrower will make a vehicular loan payment is therefore valuable for the lending institution. Moreover, obtaining geospatial data to pinpoint the location of the borrower or to determine the type of driving behavior that may trigger an event (indicative of default or delinquency) may only be possible if the borrower proactively provides the lending institution or provider his/her location of interest (to be monitored) (e.g., a work address or a home address). Dynamically determining an event affecting the asset or a landmark to be monitored may therefore be very valuable to a lending institution, which may not want to rely on the borrower for this information.

For example, one reliable indicator of whether or not the borrower will make a vehicular loan payment is likely dependent on the employment situation of the borrower. If the borrower does not regularly show up to his/her place of employment, it is possible that the borrower will miss the monthly loan payment because it may be reasonable to infer that the borrower has lost his/her job. If the borrower regularly shows up to his/her place of employment, it is likely that the borrower will make the monthly loan payment because it may be reasonable to infer that the borrower is making and collecting income. Therefore, a borrower's attendance to his/her place of employment may be one of many predictive indicators of default, delinquency, or total loss of value of the lending institution's asset (i.e., the vehicle).

### SUMMARY

A method of alert generation based on a geographic transgression of a vehicle is disclosed. In one aspect, the method includes associating a geospatial boundary area with a vehicle currently having a security interest. The method may include determining that the vehicle currently having the security interest has transgressed the geospatial boundary area and may also include generating an alert communication to a party having the security interest in the vehicle (e.g., a lender) based on the transgression.

The party having the security interest in the vehicle may be an organization that possesses the security interest in the vehicle. It may also be an agent of the organization (e.g., a bank, a credit union, a dealership finance company, a private lender, etc.) that possesses the security interest in the vehicle. The method may also comprise automatically determining a location of the geospatial boundary area associated with the vehicle based on a situs of a purchaser, a lessee, or a renter of the vehicle, all of whom may be a borrower from the perspective of the lender (i.e., the lending institution). It may also be the case that the situs is a home address or a work address of the borrower (i.e., the purchaser, the lessee, or the renter of the vehicle).

In another aspect, the method may involve periodically analyzing a geospatial location of the vehicle when a communication from a module in the vehicle (e.g., a transmitter) is processed. The method may then involve determining a pattern of usage associated with the vehicle based on the periodic analysis of the geospatial location of the vehicle. An algorithm may then be applied to determine either an optimal geospatial boundary area associated with the vehicle based on the pattern of usage or optimal usage associated with the vehicle based on the pattern of usage (e.g., travelling at least 10 miles a day). Both the geospatial boundary area and the optimal usage may be automatically adjusted based on an application of the algorithm.

The method may include geospatial data based notification of an event or series of events affecting the collateral that may include permitting a lender access to geospatial data associated with the collateral through a transmitter installed within the collateral. A data link may be established from a base terminal communicatively coupled to the transmitter such that geospatial data associated with the collateral may be transmitted from the transmitter to the base terminal via the data link. In addition, a location of the collateral may be determined based on geospatial data received from the transmitter via the data link. The geospatial data associated with the collateral may be compared to an event or pattern of events (e.g., a predetermined usage profile) and an alert communication may be generated when this geospatial data matches the event or pattern of events. The alert communication may then be used to notify the lender when geospatial data received from the transmitter matches the event or pattern of events.

In one aspect, the method permitting the lender access to geospatial data associated with the collateral through the transmitter installed within the collateral may further comprise providing a base receiver within the collateral such that the base receiver may be capable of receiving a transmit request signal. In another aspect, the method wherein establishing a data link from the base terminal to the transmitter such that geospatial data associated with the collateral is transmitted from the transmitter to the base terminal via the data link may further comprise establishing a data link from the base terminal to a base receiver upon request by the base terminal of geospatial data associated with the collateral from the transmitter installed within the collateral and may receive a transmit request signal from the base terminal with the base receiver via the data link.

Further, it is contemplated that the collateral may be a vehicle or an automobile and the collateral may comprise a vehicle or automobile that is associated with a borrower. In some other aspects, a GPS receiver may be installed, or may have been previously installed, within the collateral such that geospatial data that is transmitted from the transmitter to the base terminal via the data link may be based upon a received GPS signal. Further, the transmitter and base terminal may both be mobile electronic devices. The method may also include an aspect wherein the data link from the base terminal to the transmitter may be established at predetermined intervals and the event (affecting the collateral) may be determined by a provider or a lender. In one aspect, the event may be associated with a geographical location of the vehicle and the event may comprise one or more of the following actions: the collateral may not have moved from its current location for a period of time, the collateral may not have traveled a predetermined distance for a period of time, and the collateral may not have been at a predetermined location. It is contemplated that the predetermined distance, the predetermined location and the period of time may be determined by a lender or a provider, according to one or more aspects.

Additionally, the predetermined location may in one instance be provided by the lender or its agent, or in another instance be dynamically generated by the provider and/or lender using geospatial data. The provider may utilize the location and the time of start/stop ignition events of the collateral to generate a dynamic landmark. The predetermined location, whether provided by the lender or generated by the provider, may be stored, inventoried, analyzed, and categorized.

Finally, some aspects may involve utilizing the event or pattern of events to determine one or more of the following: a predictive indicator of default of a loan, a delinquency of the loan, and a reduction in value or total loss of value of the collateral. The geospatial data needed for this implementation may be gathered by using a system of dynamic landmarks. Notification to the lender if geospatial data received from the transmitter matches the event or pattern of events may be in the form of one or more of the following: an exception report, an email, a telephone call, a facsimile transmission, an internet communication, and a system alert. Other aspects may involve determining other indicators of loan performance and other forms of communicating to the lender. The lender may be a financial institution, an automobile dealership, a specialty finance company, a dealership finance company, a bank, a credit union, or a private financier.

### BRIEF DESCRIPTION OF THE DRAWINGS

Example embodiments are illustrated by way of example and not limitation in the figures of the accompanying drawings, in which like references indicate similar elements and in which:

FIG. 1A illustrates a location view of the vehicle having the security interest within the geospatial boundary area, according to one or more embodiments.

FIG. 1B illustrates a transgression view of the vehicle having the security interest outside the geospatial boundary area and an alert communication being transmitted to a party, according to one or more embodiments.

FIG. 2A illustrates an organization view of the vehicle having the security interest tied to a party which may be an organization, according to one or more embodiments.

FIG. 2B illustrates an agency view wherein the party having the security interest in the vehicle may be an entity or organization that possesses the security interest in the vehicle, according to one or more embodiments.

FIGS. 3A and 3B illustrate the situs of the purchaser, lessee or renter of the vehicle and the situs being the home address or work address, according to one or more embodiments.

FIG. 4 is a flow chart illustrating analyzing geospatial data, determining a pattern of usage, applying an algorithm to determine an optical geospatial boundary area and automatically adjusting the geospatial boundary area, according to one or more embodiments.

FIG. 5 illustrates a collateral view of the functioning of the transmitter, the base receiver and the base terminal in relation to the vehicular collateral, according to one or more embodiments.

FIG. 6A illustrates a geospatial data view of geospatial data received at the base terminal from the transmitter being transmitted to the lender, according to one or more embodiments.

FIG. 6B is an event view of a data illustrating an alert communication notifying a lender if a predetermined event matches the geospatial data, according to one or more embodiments.

FIG. 7 is a flow chart illustrating establishing a data link between a base terminal and a transmitter, receiving geospatial data associated with a collateral and matching the geospatial data to an event specified by a lender, according to one or more embodiments.

FIG. 8 is a module view illustrating the contents of a module and processes that may occur within, according to one or more embodiments.

FIG. 9 is a diagrammatic view of a data processing system in which any of the embodiments disclosed herein may be performed, according to one embodiment.

Other features of the present embodiments will be apparent from the accompanying drawings and from the detailed description that follows.

### DETAILED DISCLOSURE

A method comprising associating a geospatial boundary area 102 with a vehicle 104 currently having a security interest 106 is disclosed. In one embodiment, the method may include determining that the vehicle 104 currently having the security interest 106 may have transgressed the geospatial boundary area 102. An alert communication 112 may then be generated to a party 114 having the security interest 106 in the vehicle 104 based on the transgression. The alert communication 112 may come in the form of a periodic report that may summarize all alert communications for a determined period of time. According to one or more embodiments, the party 114 having the security interest 106 in the vehicle 104 may be an organization 202 that may possess the security interest 106 in the vehicle 104. In addition, the party 114 having the security interest 106 in the vehicle 104 may be an agent (i.e., an agency relationship) of an entity 204 or organization 202 that may possess the security interest 106 in the vehicle 104.

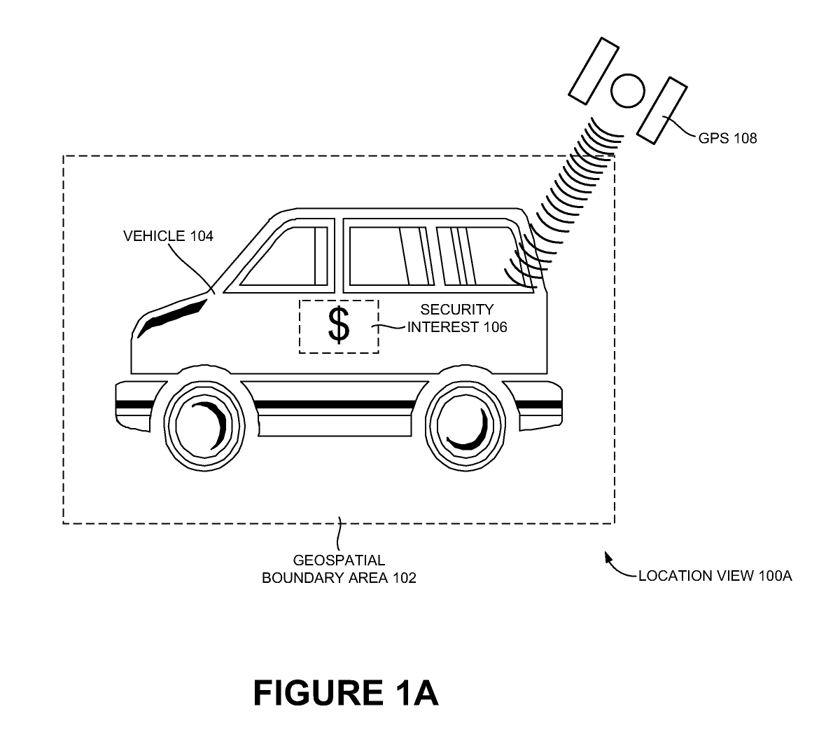

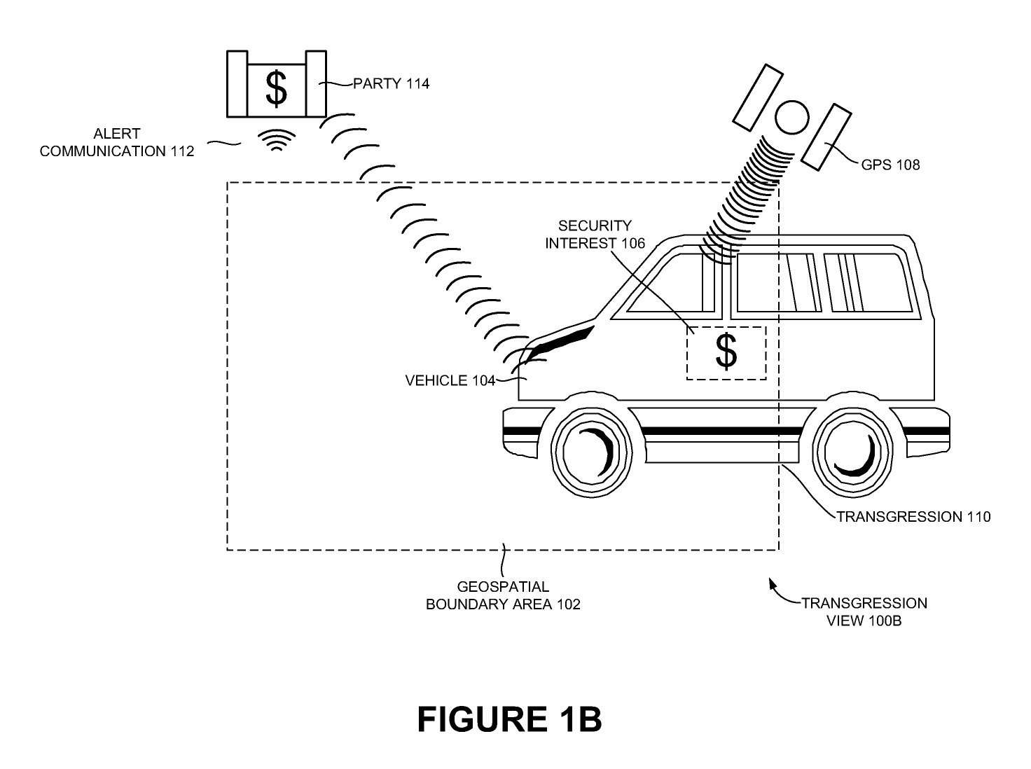

FIG. 1A illustrates a location view of the vehicle 104 having the security interest 106 within the geospatial boundary area 102, according to one or more embodiments. The security interest 106 may be a property interest created by agreement (e.g., a loan agreement between a lender and a borrower) or by operation of law over assets (e.g., a vehicle 104) to secure the performance of an obligation, usually the payment of a debt (e.g., a loan obligation). It may give the beneficiary (e.g., a lender 604) of the security interest 106 certain preferential rights in the disposition of secured assets (e.g., the vehicle 104). Such rights may vary according to the type of security interest, but in most cases, a holder of the security interest 106 may be entitled to seize, and usually sell, the vehicle 104 to discharge the debt that the security interest 106 may secure, according to one or more exemplary embodiments.

FIG. 1B illustrates a transgression view of the vehicle 104 infringing or going beyond the bounds of the geospatial boundary area 102, according to one embodiment. This infringement of the geospatial boundary area 102 may qualify as an event that may generate an alert communication 112 to a party 114 having the security interest 106 in the vehicle 104. For example, the vehicle 104 may transgress the geospatial boundary area 102. This action of the borrower transgressing the geospatial boundary area 102 may have been predetermined by a lender 604 as an event necessitating the generation of an alert communication 112. The alert communication 112 may then be generated and transmitted to the lender 604 based on the transgression of the geospatial boundary area 102, according to one or more exemplary embodiments. In addition, the vehicle 104's attendance and/or presence at or within a geospatial boundary area 102 may be algorithmically analyzed to determine a pattern of usage which may also trigger an alert communication 112, according to one or more embodiments. Also, a single breach and/or infringement of the geospatial boundary area 102 may trigger an alert communication 112 based on non-optimal geospatial boundaries (e.g., an impound lot) according to one or more embodiments. According to one exemplary embodiment, a Vehicle Identification Number (VIN) detection technology may be implemented to decipher whether the vehicle 104 being monitored is the correct vehicle (i.e., the vehicle 104 belongs to the borrower). This VIN detection technology may also be applied, in one exemplary embodiment, to discover if the transmitter 504 has been transferred to another vehicle.

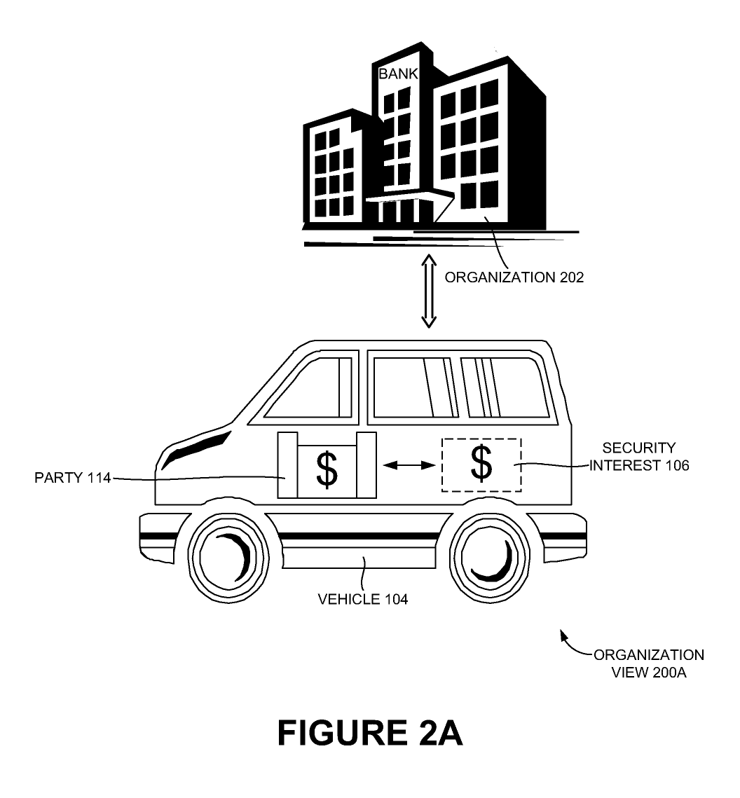

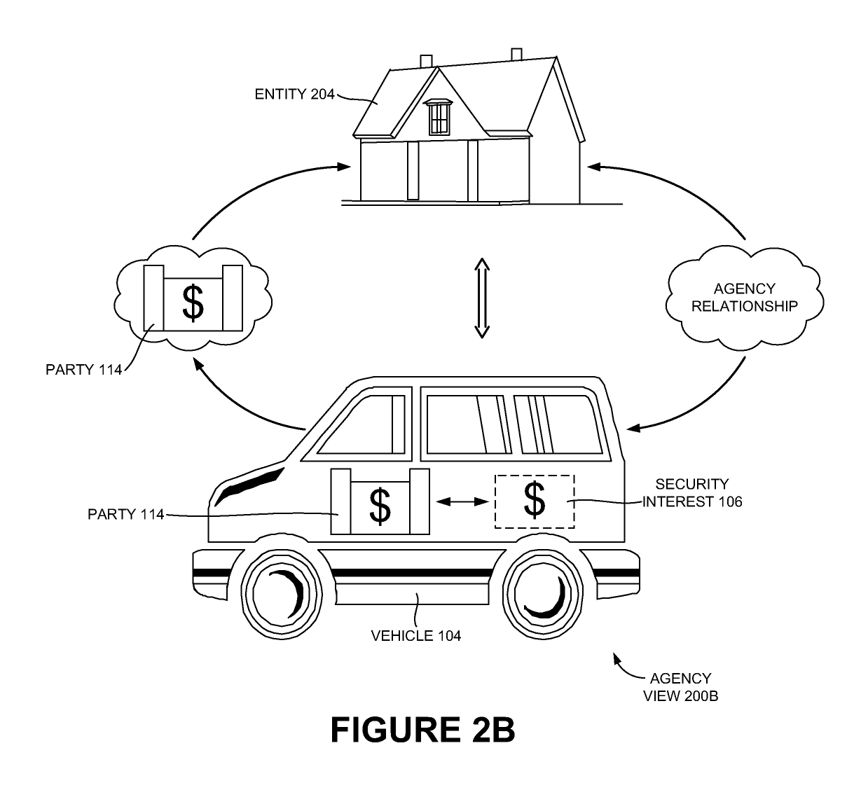

It will be appreciated that, according to one or more embodiments, the party 114 having the security interest 106 in the vehicle 104 may be an organization 202, as illustrated in FIG. 2A. This organization 202 may possess the security interest 106 in the vehicle 104. The organization 202 may be a corporation, a partnership, an individual, a government, a non-governmental organization, an international organization, an armed force, a charity, a not-for-profit corporation, a cooperative, or a university. It may be a hybrid organization that may operate in both the public sector and the private sector, simultaneously fulfilling public duties and developing commercial market activities, according to one or more embodiments. According to other embodiments, and as illustrated in FIG. 2B, the party 114 having the security interest 106 in the vehicle 104 may be an agent of an entity 204 or organization 202 (e.g., a bank, a lender 604, or any other lending institution or person) that may possess the security interest 106 in the vehicle 104. The relationship between the entity 204 or organization 202 and the party 114 may expressly or impliedly authorize the party 114 to work under the control and on behalf of the entity 204 or organization 202. The party 114 may thus be required to negotiate on behalf of the entity 204 or organization 202 to secure and/or provide services, according to one embodiment.

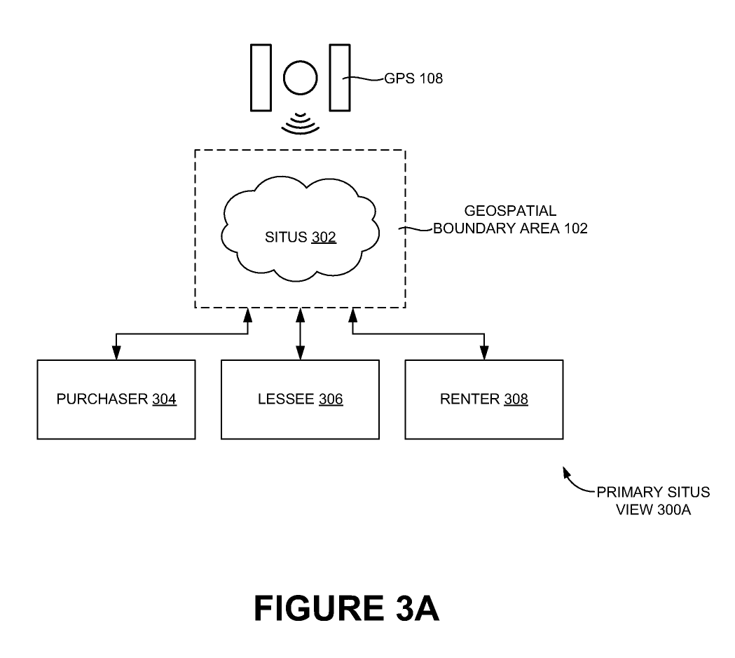

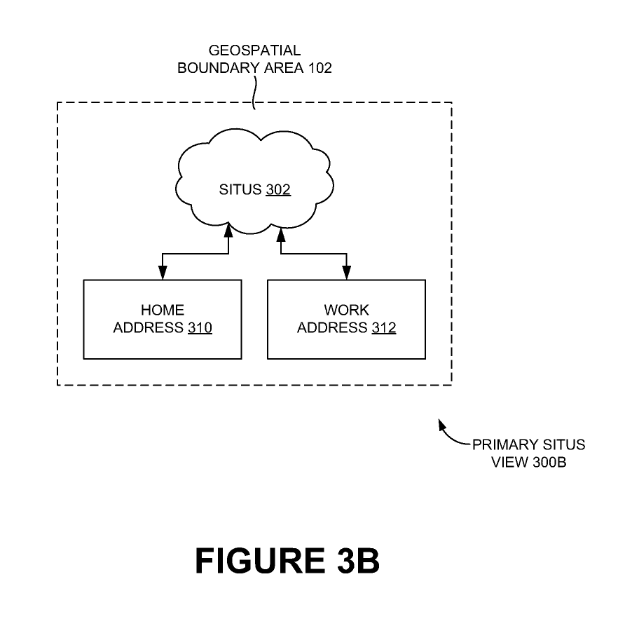

In one or more embodiments, a location of the geospatial boundary area 102 may be automatically determined based on a situs 302 of a purchaser 304, a lessee 306, or a renter 308 of the vehicle 104 as illustrated in FIG. 3A. The situs 302 may be determined using GPS 108 technology and may be the location where the borrower's (e.g., a purchaser 304, a lessee 306, or a renter 308 of the vehicle 104) property may be treated as being located for legal and jurisdictional purposes, according to one embodiment. The situs 302 may also be the place where property is situated (e.g., the impound lot). It may also be the permanent location of certain property (e.g., the borrower's location of work or the borrower's home). As illustrated in FIG. 3B and according to one or more embodiments, the situs 302 may be a home address 310 or a work address 312 of the borrower (e.g., a purchaser 304, a lessee 306, or a renter 308 of the vehicle 104). The borrower may have multiple locations, according to one embodiment.

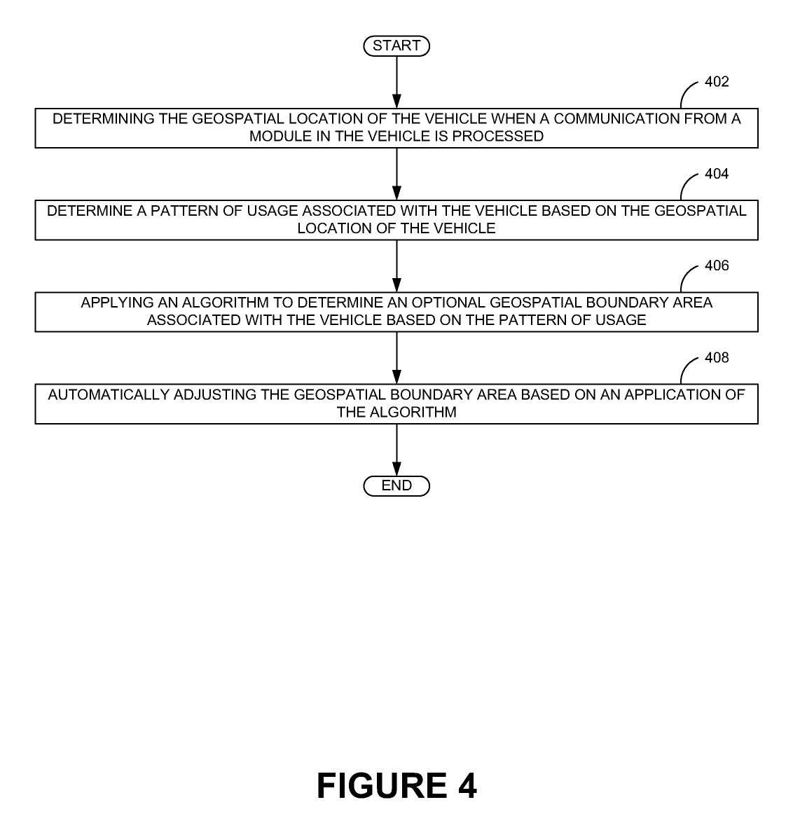

The method may also involve periodically analyzing a geospatial location of the vehicle 104 when a communication from a module in the vehicle is processed, according to one embodiment and as illustrated in FIG. 4. A pattern of usage may then be associated with the vehicle 104 based on the periodic analysis of the geospatial location of the vehicle 104. This pattern of usage may include a particular predetermined movement of the vehicle 104. For example, and according to one or more embodiments, the vehicle 104 may not have moved from its current location for a period of time, the borrower of the vehicle 104 may leave the state and/or country, the vehicle 104 may not have been driven for a certain period of time, or the vehicle 104 may have been driven, but too infrequently (e.g., less than 10 miles). The number of ignition starts and stops (e.g., the borrower may not have started the vehicle 104 for a period of time or may have only started the vehicle 104 once in a given week) and the vehicle 104 moving without the vehicle 104 being turned on (e.g., a sign the vehicle 104 may be getting towed) may also be communicated as a pattern of usage. The amount of time may vary as determined by either a lender (e.g., a bank or lending institution) or a provider (e.g., a company selling GPS transmitters and/or a company providing the corresponding web interface to track vehicles). The provider may sell the transmitter 504 hardware and/or may provide a software solution to track the vehicle 104, according to one or more exemplary embodiments.

According to one embodiment, an algorithm may be applied to determine an optimal geospatial boundary area 102 associated with the vehicle 104 based on the pattern of usage. For example, the vehicle 104 may have not arrived at the borrower's home for the past two weeks. The amount of time and the distance traveled may vary as determined by either a lender (e.g., a bank or lending institution) or a provider (e.g., a company selling GPS transmitters and/or a company providing the corresponding web interface to track vehicles), according to one or more embodiments. Further, and according to one embodiment, the geospatial boundary area 102 may be automatically adjusted based on an application of the algorithm. For example, if the borrower's vehicle 104 has left the state of his/her domicile, the algorithm may lower the threshold for triggering an alert communication 112 related to another event 608B (e.g., the number of days not at work). The adjustments may be based on predetermined locations, predetermined distances, or predetermined times decided by either the lender 604 or the provider and gleaned from geospatial data 602 and/or the geospatial boundary area 102.

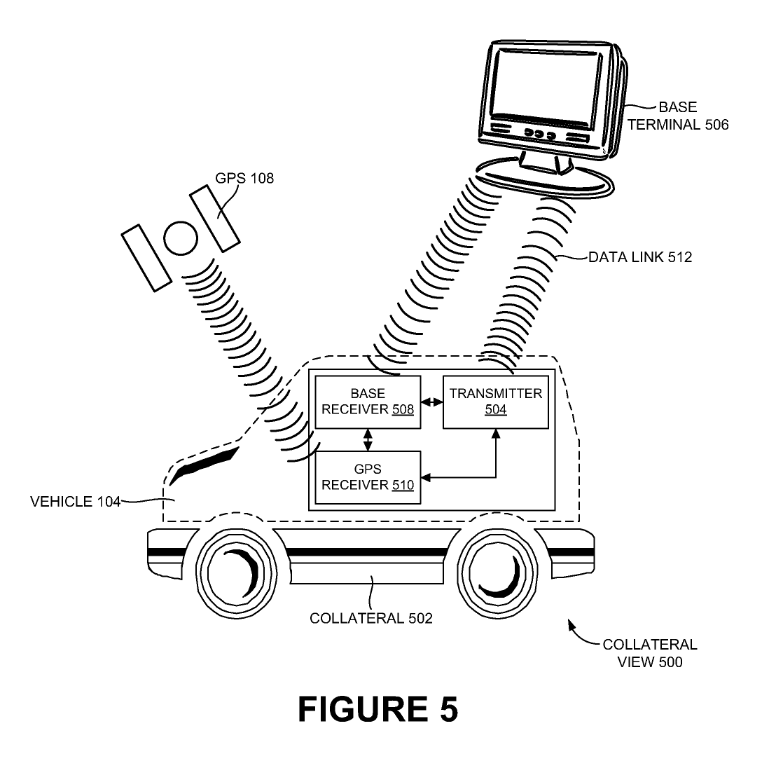

FIG. 5 illustrates a collateral view wherein a GPS receiver 510 receives a GPS signal from a GPS 108, according to one or more embodiments. A base receiver 508 may receive a signal from a base terminal 506 requesting geospatial data 602 captured by the GPS receiver 510. This geospatial data 602 may then be transmitted by the transmitter 504 from the collateral 502 (i.e., the vehicle 104) to the base terminal 506, via the data link 512, according to one embodiment. The base receiver 508, the GPS receiver 510, and the transmitter 504 may be communicatively coupled with each other and may together be communicatively coupled with the base terminal 506. The data link 512 may be established periodically or permanently. All functions may be performed by a machine readable medium embodying a set of instructions when executed by a machine may cause the machine to perform the methods, herein described.

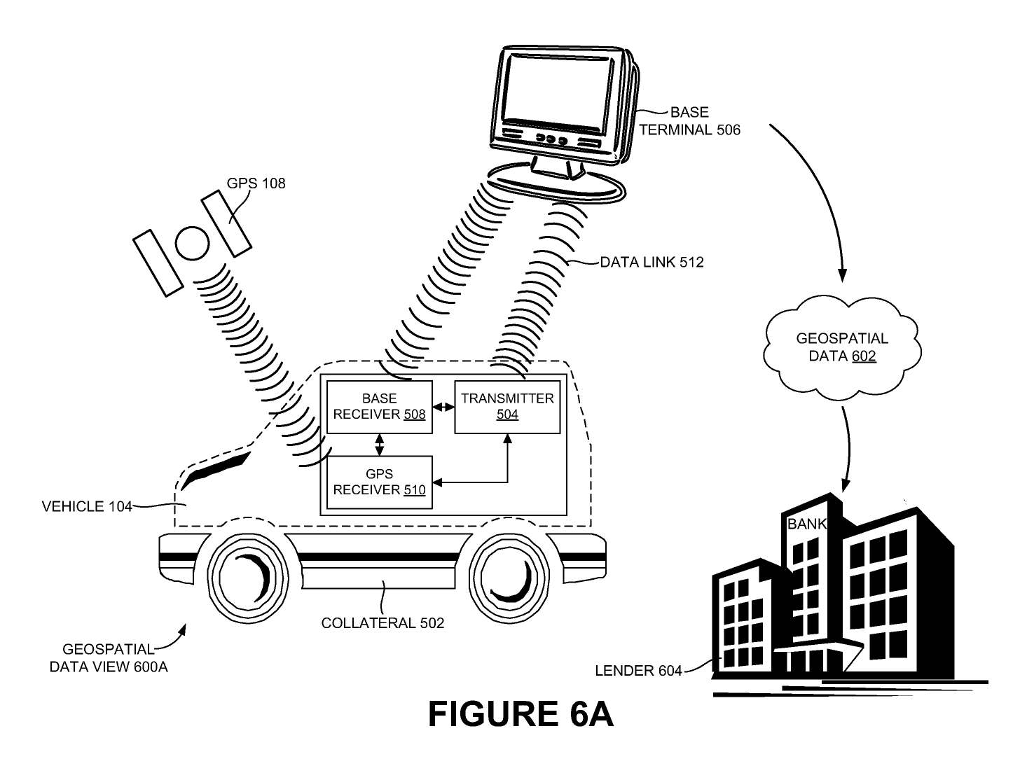

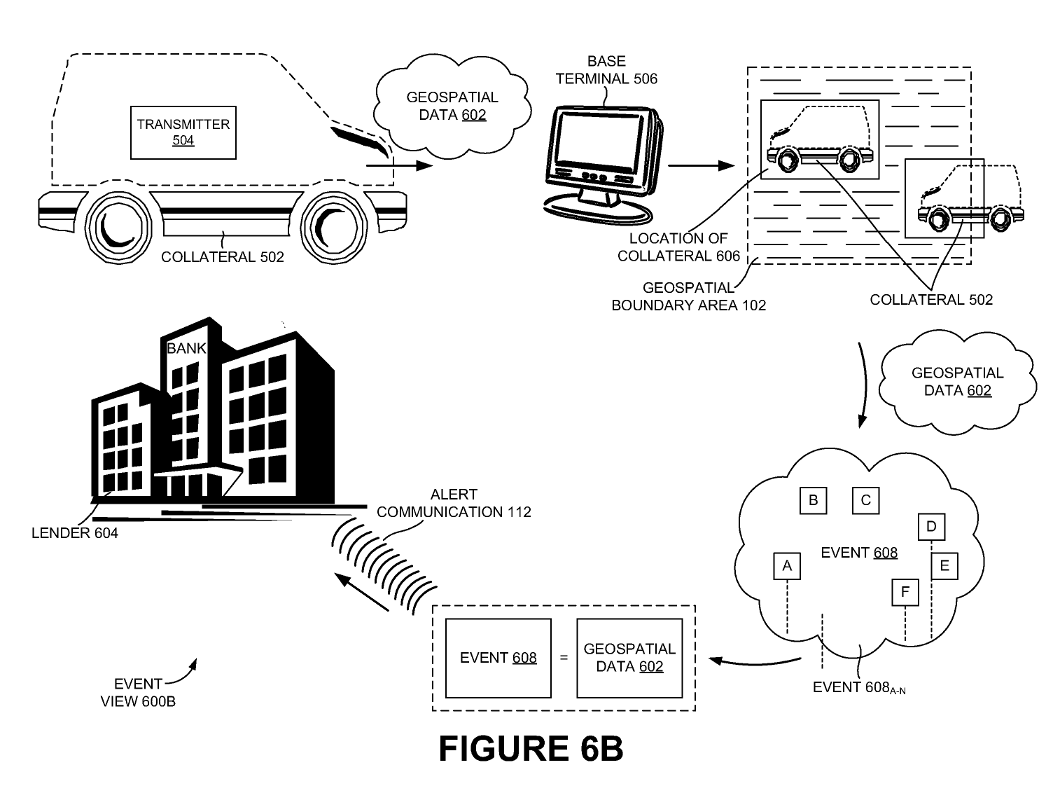

It will be appreciated that according to one or more embodiments, and as illustrated in FIG. 6A, geospatial data 602 based notification of an event 608 affecting a collateral 502 may comprise permitting a lender 604 access to geospatial data 602 associated with the collateral 502 through a transmitter 504 installed within the collateral 502. The event 608 may not be a specific event but rather a pattern of multiple algorithmically determined events (e.g., events 608 A-N as depicted in FIG. 6B). A data link 512 may be established from a base terminal 506 communicatively coupled to a transmitter 504 such that geospatial data associated with the collateral 502 (e.g., the vehicle 104) may be transmitted from the transmitter 504 to the base terminal 506 via the data link 512. According to one embodiment, a location of the collateral 502 may be determined based on geospatial data 602 received from the transmitter 504 via the data link 512. The geospatial data 602 received from the transmitter 504 may then be compared to an event 608. According to FIG. 6B and one or more exemplary embodiments, an alert communication 112 may be generated when geospatial data 602 received from the transmitter 504 matches the event 608 and the lender 604 may be notified. In another embodiment, the event 608 may comprise a low power and power ON/OFF event and may be helpful to reduce tampering and/or problems with the vehicle 104. If a power ON/OFF event occurs too frequently, the borrower may become dissatisfied and not pay the lender 604 or may end up spending too much money on repairing vehicle 104 and may be late in paying the lender 604. In addition, and according to another embodiment, the frequency of the power ON/OFF event may also dictate whether the borrower is missing work. Combining the efficacies of the power ON/OFF event and the movement of the vehicle 104, may provide the lender 604 with a superior method of assessing whether the borrower has an increased likelihood of defaulting on his/her loan obligations or whether the borrower may become delinquent on his/her loan payments, according to one or more exemplary embodiments.

The event 608 may be any event based on a geospatial boundary area 102 or geospatial data 602 associated with the collateral 502 or vehicle 104. The event 608 may be a predetermined combination of events including locations and times associated with the borrower and vehicle 104 and based on the vehicle's geospatial location gleaned by geospatial data 602 and assessed in relation to the geospatial boundary area 102. The event may be predetermined by a lender or a provider. According to one embodiment, the event may be a location based (e.g., location based on geospatial data 602 or geospatial boundary area 102) predictive indicator of default, delinquency, or partial or total loss of value of an asset (e.g., a vehicle 104 used as collateral 502). For example, based on discussions with the lender 604, if the vehicle 104 has not been started or has been driven fewer than 20 miles in 14 days, the risk of delinquency and eventual default may increase significantly. The lender 604 may be any financial institution, dealership, specialty finance company, dealership finance company, bank, or any other organization 202 that lends money to consumers (i.e., a borrower) to fund the purchase of the vehicle 104. The vehicle 104, according to one or more embodiments, may be an asset (e.g., the vehicle may be used as collateral by a lender in a loan transaction) and may refer to all forms of transportation including cars, motorcycles, planes, trucks, heavy equipment, jet skis, and all other modes of commercial and/or recreational transportation.

According to other embodiments, a borrower may be an individual or group of individuals that may have an outstanding loan with a lender 604. The borrower may receive the vehicle 104 on the promise to make periodic and timely loan payments to the lender 604. In one embodiment, the event 608 may comprise the vehicle 104 not having “checked-in” to a certain predetermined location. For example, the borrower may indicate to the lender 604 his or her home address 310 or work address 312. The lender 604 may set a geo-fence (e.g., a geospatial boundary area 102) around the borrower's home address 310 or work address 312 and may be notified if the borrower does not drive the vehicle 104 to the home address 310 or work address 312 for a period of time. The predetermined location may be changed at any point in time either by the lender 604 directly or by the provider. The provider, according to one or more exemplary embodiments, may be a company that provides GPS devices, GPS vehicle tracking services, OEM telematics (e.g., OnStar™), payment reminder services, vehicle repossession services, or payment assurance services. The provider may also provide fleet tracking and mobile asset management services. It may also be a subprime vehicle finance and/or asset tracking company, according to one embodiment.

According to one or more exemplary embodiments, the geospatial boundary area 102 (e.g., a geo-fence) may be a virtual perimeter for a real-world geographic area. The geospatial boundary area 102 may be dynamically generated—as in a radius around a place of work or point location. Or the geospatial boundary area 102 may be a predefined set of boundaries (e.g., a school attendance zone, a neighborhood boundary, a state outside the location of vehicle 104, or a tow lot). A custom-digitized geospatial boundary area 102 may also be employed, according to one embodiment. When the transmitter 504 installed within a collateral 502 enters or exits the geospatial boundary area 102, the base terminal 506 may receive a generated notification. This notification might contain information about the location of the vehicle 104. The geospatial boundary area 102 may be a critical element to telematics hardware and software. It may allow users of the transmitter 504, the lender 604 or the provider to draw zones around places of work, customer sites and other areas (e.g., a situs 302). The geospatial boundary area 102 may be linked to immobilization equipment within the vehicle 104 (e.g., a starter disable) and may stop the engine dead, according to one or more exemplary embodiments.

Further, in addition to permitting the lender 604 access to geospatial data 602 associated with the collateral 502 through the transmitter 504 installed within the collateral 502, a base receiver 508 may be provided within the collateral 502 such that the base receiver 508 may be capable of receiving a transmit request signal (e.g., from the base terminal 506 for geospatial data 602 from the transmitter 504). According to one embodiment, a data link 512 may be established from the base terminal 506 to the base receiver 508 upon request by the base terminal 506 of geospatial data 602 associated with the collateral 502 from the transmitter 504 installed within the collateral 502. The data link 512 may also be used to transmit a transmit request signal from the base terminal 506 to the base receiver 508. It will be appreciated that, according to one or more embodiments, the transmitter 504 may establish a data link 602 to the base terminal 506. The transmitter 504 may author geospatial data 602 from time or event 608 A-N based triggers according to an exemplary embodiment.

According to one or more exemplary embodiments, the collateral 502 may be a vehicle 104 and the collateral 502 comprising the vehicle 104 may be associated with a borrower. In addition, the GPS receiver 510 may be installed within the collateral 502 such that geospatial data 602 that is transmitted from the transmitter 504 to the base terminal 506 via the data link 512 may be based upon a received GPS signal (e.g., from GPS 108). In one or more embodiments, the transmitter 504 and the base terminal 506 may be mobile electronic devices and the data link 512 from the base terminal 506 to the transmitter 504 may be established at predetermined intervals. In other embodiments, the event 608 may be determined by the provider or the lender 604 and may be associated with a geographical location of the vehicle 104. The event may also comprise at least one of the following: the collateral 502 not having moved from its current location for a period of time, the collateral 502 not having traveled a predetermined distance for a period of time, and the collateral 502 not having been at a predetermined location. The predetermined distance and predetermined location may be determined by the lender 604 or the provider according to one or more embodiments.

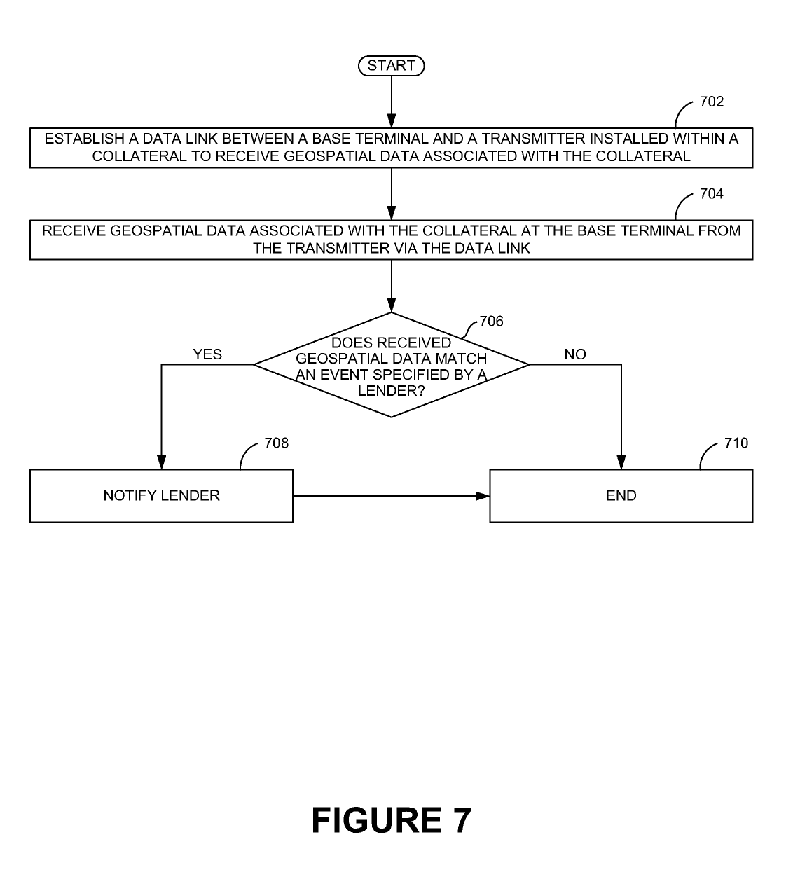

FIG. 7 is a flow chart illustrating establishing a data link 512 between a base terminal 506 and a transmitter 504 installed within a collateral 502 to receive geospatial data 602 associated with the collateral 502, according to one embodiment. Additionally, the geospatial data 602 associated with the collateral 502 may be received at the base terminal 506 from the transmitter 504 via the data link 512. A comparison or match may then be performed, according to one or more embodiments, to check whether the received geospatial data 602 matches an event 608 specified by a lender 604 or borrower. If the received geospatial data 602 matches the specified event 608, the lender 604 may then be notified. The event 608 may be associated with a geographical location of the vehicle 104 as gleaned by the geospatial data 602 and predetermined by the lender 604 or the provider, according to one embodiment.

The base terminal 506 may interrogate the transmitter 504, according to one or more exemplary embodiments. Upon interrogation of the base terminal 506 by the transmitter 504 via the data link 512, geospatial data 602 associated with the collateral 502 may be generated and may be received at the base terminal 506 via the data link 512. It may then be determined whether geospatial data 602 received from the transmitter 504 matches an event 608 specified by the lender 604 or borrower. The lender 604, or an agent of the lender 604, may then be notified of the event 608. According to one or more embodiments, notification to the lender 604 of the event 608 may be in the form of an email, a telephone call, a Short Messaging Service (SMS) message, a facsimile transmission, an internet communication, a system alert or any other form of communication. The lender 604 may be a financial institution, an automobile dealership, a specialty finance company, a dealership finance company, a bank, a credit union, or a private financier in addition to any entity 204 or organization 202, according to one or more exemplary embodiments.

According to one or more embodiments, an ignition event associated with the vehicle 104 may be used to generate and inventory a dynamic landmark related to and associated with vehicle 104 and with events 608 A-N or multiple ignition events associated with the vehicle 104 may be used to generate and inventory multiple dynamic landmarks related to and associated with vehicle 104 and events 608 A-N. For example, the presence of the vehicle 104 inside the geospatial boundary area 102 may be determined based on an ignition status and/or time spent inside the geospatial boundary area 102. There may be multiple methods of generating the event 608 affecting the collateral 602 (i.e., vehicle 104) so that the geospatial boundary area 102 may be implemented around the vehicle 104 with the security interest 106, according to one or more embodiments. For example, a physical mailing address of the borrower or an area identifiable on a map may have been necessary for the lender 604 or provider to generate an event 608 and establish the geospatial boundary area 102 around the borrower's home address or work address. However, the location of the borrower for the geospatial boundary area 102 and event 608 may also be generated automatically using one or more ignition events to generate and inventory one or more dynamic landmarks associated with the vehicle 104 (e.g. home address 310, work address 312 etc.), according to one or more embodiments. For example, the provider may utilize location and time of start/stop ignition events to generate a dynamic landmark. The predetermined location (e.g., home address 310, work address 312, etc.), whether provided by the lender or generated by the provider, may be stored, inventoried, analyzed, and categorized according to one or more exemplary embodiments.

According to one embodiment, the dynamic landmark may be a geo-point with a tight radius. According to another embodiment, an ignition event associated with vehicle 104 may be collected and may be associated with an event 608 without knowledge of the nature of the dynamic landmark (e.g., home address 310, work address 312, etc. of the borrower) at the time of capture. In one or more exemplary embodiments, geospatial data 602 may be used for risk assessment of the collateral 502 and the collateral 502 may be the vehicle 104. The method may involve generating a dynamic landmark based on an ignition event and determining a location of the collateral 502 based on the dynamic landmark. The risk of a default or a delinquency associated with the collateral 502 (i.e., an asset) based on the dynamic landmark associated with the collateral 502 may also be assessed. A transmitter 504 based event 608 that may profile the vehicle 104 may include, but may not be limited to: an ignition event which may be real (i.e., hard wired) or virtual (i.e., movement of vehicle 104 and battery voltage of vehicle 104), a tow event (i.e., movement of vehicle 104 without ignition), an ignition disable event, an increased frequency of alert communications 112 to the lender 604, or a very low resolution continuous track, according to one or more embodiments.

In addition, an Intelligent Caching Engine (ICE) may be implemented and may include a method of storing incoming geospatial data 602 associated with vehicle 104 and events 608 A-N associated with vehicle 104 in a dynamic table format that may allow rapid searching of and access to multiple data points on multiple vehicles, according to one or more embodiments. The multiple data points may be stored on a per dealership basis or across all available dealers who may be looking for a lender 604, according to one or more embodiments. The ICE may execute the storing of the dynamic landmarks and may act as the storage engine for the event 608 and the dynamic landmark information (e.g., in the form of geospatial data 602). Under ICE, all events 608 A-N may be analyzed regardless of their type against geo-rules which may allow for landmark and/or geofence information to be determined on any event type (e.g., event 608 A-N) and may be calculated historically by re-analyzing previously received and/or retrieved geospatial data 602, according to one or more embodiments. It will be appreciated that the ICE may have the ability to count the dynamic landmark events and may also have the ability to rapidly compute the time spent by the borrower at each dynamic landmark, according to one or more exemplary embodiments.

It will also be appreciated that, according to one or more embodiments, the dynamic landmarks may be placed in a library. Events 608 A-N may be stated up against the library and may provide valuable information to the lender 604 or the provider. Example library elements may include, but are not limited to: impound yards, dealer lots, zip codes, states, and economic zones, according to one or more exemplary embodiments. For example, vehicle 104 (or multiple vehicles) which may be located at a common dynamic landmark for a number of days may identify a possible impound yard which may then be added to the library, according to one embodiment.

Although the present embodiments have been described with reference to specific example embodiments, it will be evident that various modifications and changes may be made to these embodiments without departing from the broader spirit and scope of the various embodiments. For example, the various devices (e.g., the base terminal 506, the transmitter 504, the base receiver 508, the GPS receiver 510 etc.), modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry). For example, data transmission technologies, transmitters, and devices other than ones employing GPS technology (e.g., RFID, RTLS, OEM telematics, location detection based on cell phone towers, electromagnetic waves, optical emissions, infrared, radar, sonar, radio, Bluetooth™ etc.) may be used to transmit geospatial data 602 and the alert communication 112 for the purposes of the invention described herein, according to one or more exemplary embodiments.

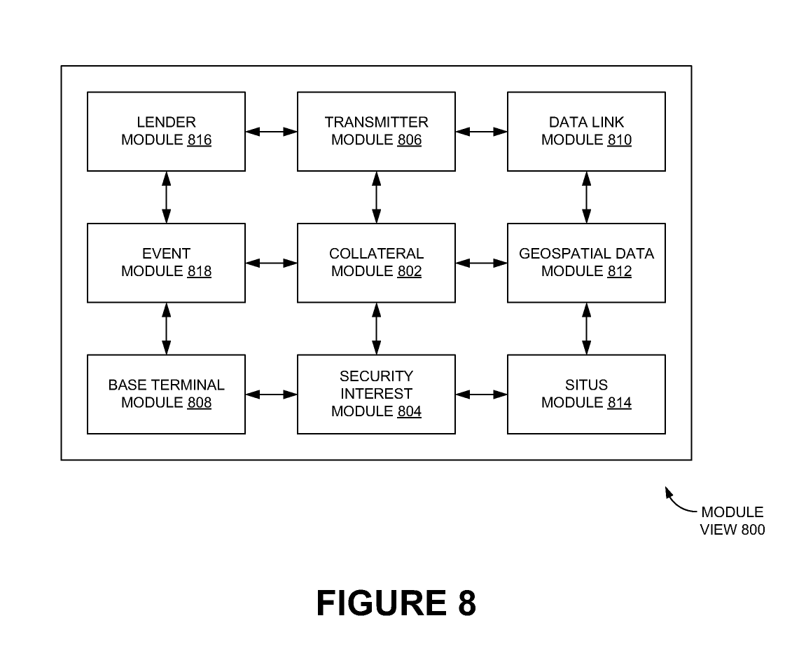

Particularly, several modules as illustrated in FIG. 8 may be employed to execute the present embodiments. The collateral module 802, the security module 804, the transmitter module 806, the base terminal module 808, the data link module 810, the geospatial data module 812, the situs module 814, the lender module 816, the event module 818 and all other modules of FIGS. 1-8 may be enabled using software and/or using transistors, logic gates, and electrical circuits (e.g., application specific integrated ASIC circuitry) such as a security circuit, a recognition circuit, a dynamic landmark circuit, an ignition event circuit, a store circuit, a transform circuit, an ICE circuit, and other circuits.

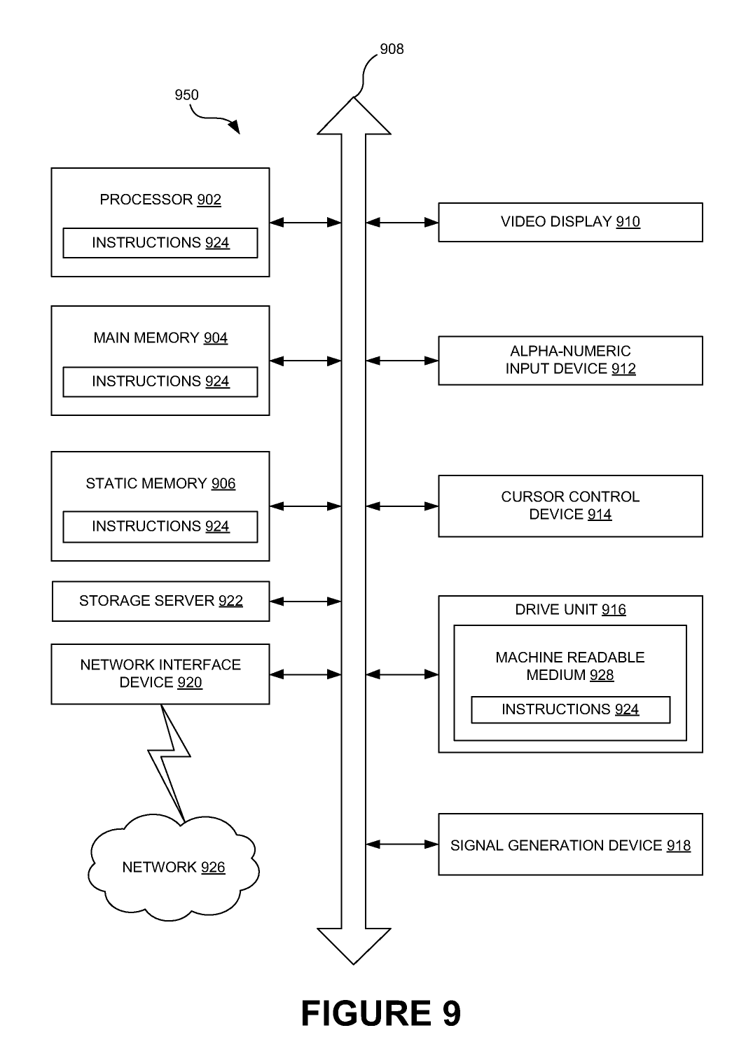

FIG. 9 may indicate a personal computer and/or the data processing system in which one or more operations disclosed herein may be performed. The processor 902 may be a microprocessor, a state machine, an application specific integrated circuit, a field programmable gate array, etc. (e.g., Intel® Pentium® processor, 620 MHz ARM1176®, etc.). The main memory 904 may be a dynamic random access memory and/or a primary memory of a computer system. The static memory 906 may be a hard drive, a flash drive, and/or other memory information associated with the data processing system. The bus 908 may be an interconnection between various circuits and/or structures of the data processing system. The video display 910 may provide graphical representation of information on the data processing system. The alpha-numeric input device 912 may be a keypad, a keyboard, a virtual keypad of a touchscreen and/or any other input device of text (e.g., a special device to aid the physically handicapped). The cursor control device 914 may be a pointing device such as a mouse. The drive unit 916 may be the hard drive, a storage system, and/or other longer term storage subsystem. The signal generation device 918 may be a bios and/or a functional operating system of the data processing system. The network interface device 920 may be a device that performs interface functions such as code conversion, protocol conversion and/or buffering required for communication to and from the network 926. The machine readable medium 928 may provide instructions on which any of the methods disclosed herein may be performed. The instructions 924 may provide source code and/or data code to the processor 902 to enable any one or more operations disclosed herein.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method comprising:
associating a geospatial boundary area with a vehicle currently having a security interest;
determining that the vehicle currently having the security interest has transgressed the geospatial boundary area; and
generating an alert communication to a party having the security interest in the vehicle based on the transgression.

2. The method of claim 1 wherein the party having the security interest in the vehicle is an organization that possesses the security interest in the vehicle.

3. The method of claim 1 wherein the party having the security interest in the vehicle is an agent of an entity that possesses the security interest in the vehicle.

4. The method of claim 1 further comprising:
automatically determining a location of the geospatial boundary area associated with the vehicle based on a situs of at least one of a purchaser, a lessee, and a renter of the vehicle.

5. The method of claim 4 wherein the situs is at least one of a home address and a work address of the purchaser, the lessee, and the renter.

6. The method of claim 1 in a form of a machine readable medium embodying a set of instructions that when executed by a machine causes the machine to perform the method of claim 1.

7. The method of claim 1 further comprising:
periodically analyzing a geospatial location of the vehicle when a communication from a module in the vehicle is processed;
determining a pattern of usage associated with the vehicle based on the periodic analysis of the geospatial location of the vehicle;
applying an algorithm to determine an optimal geo spatial boundary area associated with the vehicle based on the pattern of usage; and
automatically adjusting the geospatial boundary area based on an application of the algorithm.

8. A method of geospatial data based notification of an event affecting a collateral comprising:
permitting a lender access to geospatial data associated with the collateral through a transmitter installed within the collateral;
establishing a data link from a base terminal communicatively coupled to the transmitter such that geo spatial data associated with the collateral is transmitted from the transmitter to the base terminal via the data link;
determining a location of the collateral based on geospatial data received from the transmitter via the data link;
comparing geospatial data received from the transmitter to the event;
generating an alert communication when geospatial data received from the transmitter matches the event; and
notifying the lender when geospatial data received from the transmitter matches the event.

9. The method of claim 8 wherein permitting the lender access to geospatial data associated with the collateral through the transmitter installed within the collateral further comprises providing a base receiver within the collateral such that the base receiver is capable of receiving a transmit request signal.

10. The method of claim 8 wherein establishing a data link from the base terminal to the transmitter such that geospatial data associated with the collateral is transmitted from the transmitter to the base terminal via the data link further comprises:
establishing a data link from the base terminal to a base receiver upon request by the base terminal of geospatial data associated with the collateral from the transmitter installed within the collateral; and
receiving a transmit request signal from the base terminal with the base receiver via the data link.

11. The method of claim 8:
wherein the collateral is a vehicle; and
wherein the collateral comprising the vehicle is associated with a borrower.

12. The method of claim 8:
wherein the wherein a GPS receiver is installed within the collateral such that geospatial data that is transmitted from the transmitter to the base terminal via the data link is based upon a received GPS signal.

13. The method of claim 8:
wherein the transmitter is a mobile electronic device; and
wherein the base terminal is a mobile electronic device.

14. The method of claim 8:
wherein the data link from the base terminal to the transmitter is established at predetermined intervals;
wherein the event is determined by at least one of a provider and the lender;
wherein the event is associated with a geographical location of the vehicle; and
wherein the event comprises at least one of the collateral not having moved from its current location for a period of time, the collateral not having traveled a predetermined distance for a period of time, and the collateral not having been at a predetermined location.

15. The method of claim 14:
wherein the predetermined distance is determined by at least one of the lender and the provider; and
wherein the predetermined location is dynamically generated by at least one of the lender and the provider using geospatial data.

16. A computer readable media including program instructions which when executed by a processor cause the processor to perform at least one of:
establishing a data link from a base terminal to a transmitter installed within the collateral such that geospatial data associated with the collateral is capable of being transmitted from the transmitter to the base terminal via the data link upon interrogation of the transmitter by the base terminal;
generating geospatial data associated with the collateral from the transmitter installed within the collateral by interrogation of the transmitter by the base terminal via the data link;
receiving geospatial data associated with the collateral from the transmitter installed within the collateral via the data link;
determining whether geo spatial data received from the transmitter matches an event specified by at least one of a lender and a provider; and
notifying the lender when geospatial data received from the transmitter matches the event.

17. The method of claim 16 wherein the event is used to determine at least one of a predictive indicator of default of a loan, a delinquency of the loan, and a reduction of value of the collateral.

18. The method of claim 16 wherein notification to the lender if geospatial data received from the transmitter matches the event is in the form of at least one of an exception report, an email, a telephone call, a facsimile transmission, an internet communication, and a system alert.

19. The method of claim 16 wherein the lender is at least one of a financial institution, an automobile dealership, a specialty finance company, a dealership finance company, a bank, a credit union, and a private financier.
